(19) United States
(12) Patent Application Publication
(10) Pub. No.: US 2023/0166297 A1
(43) Pub. Date: Jun. 1, 2023

(54) PROBE PIN CLEANING SHEET WITH CLEANING POWER AND A MANUFACTURING METHOD THEREOF

(71) Applicant: CKT TEK CO., LTD., New Taipei City (TW)

(72) Inventors: Li-Wen HSU, New Taipei City (TW); Chun-Liang CHEN, New Taipei City (TW); Chih-Tang LEE, New Taipei City (TW)

(21) Appl. No.: 17/742,158

(22) Filed: May 11, 2022

(30) Foreign Application Priority Data
Dec. 1, 2021 (TW) 110144840

(51) Int. Cl. B08B 1/00; B24D 11/02; B24D 11/00; B24D 3/22; B24D 3/00

(52) U.S. Cl. CPC B08B 1/006; B24D 3/002; B24D 3/22; B24D 11/001; B24D 11/02

(57) ABSTRACT

A probe pin cleaning sheet with cleaning power and a manufacturing method thereof are disclosed, comprising a release layer, a cleaning layer, and a substrate. Thus, in the process that the probe pin pierces the cleaning layer, through the material of cleaning layer, and the cleaning grains of abrasive material contained in the cleaning material in the cleaning layer, the cleaning power is increased to scrape off dirt from the surface of probe pin. In addition, by the negative charges and lipophilic property of the silicone itself, the dirt on the probe pin can be transferred onto the cleaning layer.

### BACKGROUND OF THE INVENTION

### A) Field of the Invention

The present invention relates to a probe pin cleaning sheet with cleaning power and a manufacturing method thereof, and more particularly to a probe pin cleaning sheet and a manufacturing method thereof.

### B) Description of the Prior Art

In testing electronic components (such as, but not limited to, a final test (FT) or chip probing (CP)), it usually requires a probe pin to measure the electric properties. However, if there are impurities or scratches on the probe pin, the test results of the electronic components may be affected.

It is known that the foreign matters can be removed by piercing the tip of a probe pin into a cleaning part such as acrylic resin or polyurethane resin. Nevertheless, the shortcoming of this method is that the fragments of cleaning part will form new foreign matters that are adhered on the tip of probe pin, or the tip of probe pin may be damaged in piercing, which often results in that the tip of probe pin is worn out excessively or the cleaning cannot be done.

To solve the abovementioned issues, a cleaning sheet used to clean a probe card was developed and sold on the market (manufactured by the Nihon Micro Coating Co. Ltd., with the product name of MIPOX). The cleaning sheet is provided with a substrate of polyurethane and has a good buffering capacity. A surface of the substrate includes a polishing layer of fine abrasive powder, and the other surface of the substrate is an adhesive layer. Due to the adhesive layer, the cleaning sheet can be adhered on the substrate, such as a silicon chip, for use. Specifically, when the cleaning sheet is adhered on the substrate which is provided with the same shape and size as that of a semiconductor chip, the probe pin can press down and contact the surface of polishing layer to remove the foreign matters.

For the cleaning sheet used to remove the foreign matters attached on the tip of probe pin, a Japanese Patent Registration No. 3072423 and a Japanese Patent Publication No. 11-238768 have disclosed a cleaning sheet used to clean the tip of probe pin, including a cleaning thin film of fine abrasive powder fixed on the surface, an elastic sheet disposed below the cleaning thin film, and a substrate disposed below the elastic sheet. These reference documents also disclose a cleaning sheet used to clean the tip of probe pin. The structure of cleaning sheet includes a hard metallic thin film which replaces the fine abrasive cleaning thin film fixed on the surface to clean the tip of probe pin. The hard metallic thin film makes the surface rough, and the elastic sheet is made of silicon rubber and polyurethane rubber.

However, these conventional probe pin cleaning sheets cannot be used in normal temperature, high temperature or low temperature. In addition, as the probe pin can be easily damaged by a hard material, the tip of probe pin cannot be cleaned gently and very efficiently.

### SUMMARY OF THE INVENTION

The object of present invention is to provide a probe pin cleaning sheet with cleaning power and a manufacturing method thereof, wherein foreign matters adhered on the tip and side of a probe pin are removed for cleaning by the contact with a cleaning layer. The cleaning sheet can be used in normal temperature, high temperature and low temperature. In addition, as the probe pin will not be damaged by a hard material, the tip of probe pin can be cleaned gently and very efficiently.

Accordingly, the probe pin cleaning sheet with cleaning power and the manufacturing method thereof include a release layer, a cleaning layer, and a substrate, wherein the release layer is disposed on a surface of the cleaning layer, the release layer can be a release film attached on a surface of the cleaning layer or a silicone coating coated on a surface of the cleaning layer, the substrate is disposed on the other surface of the cleaning layer, the cleaning layer is provided with a cleaning material, the cleaning material is formed by plural abrasive grains, each abrasive grain is formed by plural cleaning grains, the cleaning layer is made of silicone and is formed integrally with the cleaning material on the substrate, or is bonded with the substrate adhesively after being formed. Thus, in the process that the probe pin pierces the cleaning layer, through the material of cleaning layer, and the cleaning grains of abrasive material contained in the cleaning material in the cleaning layer, the cleaning power is increased to scrape off dirt from the surface of probe pin. In addition, by the negative charges and lipophilic property of the silicone itself, the dirt on the probe pin can be transferred onto the cleaning layer.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cutaway view of a prob pin cleaning sheet with cleaning power and a manufacturing method thereof, according to the present invention.

FIG. 2 shows a schematic view of continuous use of the prob pin cleaning sheet with cleaning power and the manufacturing method thereof, according to the present invention.

FIG. 3 shows another schematic view of the continuous use of the prob pin cleaning sheet with cleaning power and the manufacturing method thereof, according to the present invention.

FIG. 4 shows a block diagram of the prob pin cleaning sheet with cleaning power and the manufacturing method thereof, according to the present invention.

### DETAILED DESCRIPTION OF THE PREFERRED EMBODIMENTS

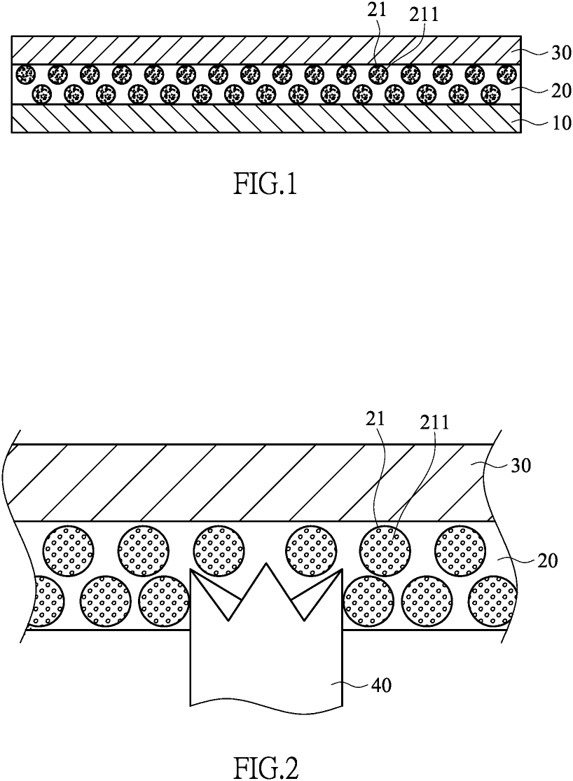

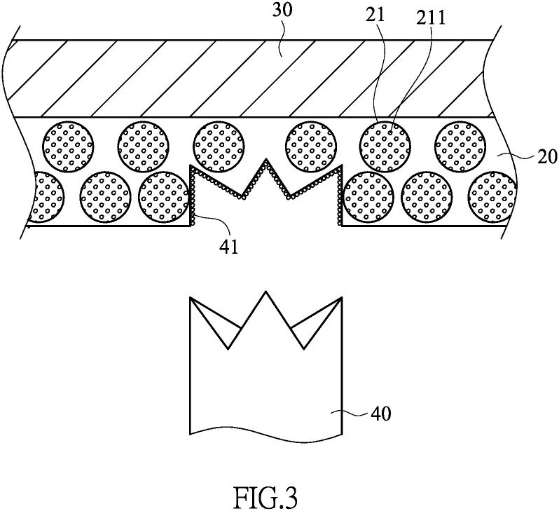

Referring to FIGS. 1 to 3, the present invention discloses a probe pin cleaning sheet with cleaning power and a manufacturing method thereof, wherein the probe pin cleaning sheet with clean power comprises a release layer 10, a cleaning layer 20 and a substrate 30.

The release layer 10 is disposed on a surface of the cleaning layer 20, and can be a release film attached on a surface of the cleaning layer 20 or a silicone coating coated on a surface of the cleaning layer 20. The release layer 10 is used primarily to protect the surface of product in shipping.

The substrate 30 is disposed on the other surface of the cleaning layer 20. The cleaning layer 20 is provided with a cleaning material. The cleaning material is formed by plural abrasive grains 21, and each abrasive grain 21 is formed by plural cleaning grains 211. The cleaning layer 20 is made of silicone (silicone resin), and is formed integrally with the cleaning material on the substrate 30, so as to save the time in adhering for clients and prevent an adhesive layer from resulting in bubbles and peeling in high temperature. In addition, the cleaning layer 20 can be also bonded with the substrate 30 adhesively after being formed.

By the abovementioned structures, in the process that the probe pin 40 pierces the cleaning layer 20, through the material of cleaning layer 20, and the cleaning grains 211 of abrasive material contained in the cleaning material in the cleaning layer 20, the cleaning power is increased to scrape off dirt 41 from the surface of probe pin 40. In addition, by the negative charges and lipophilic property of the silicone itself, the dirt 41 on the probe pin 40 can be transferred onto the cleaning layer 20.

Referring to FIGS. 1 to 3, the substrate 30 can be a fiberglass board, a plastic board, a synthetic stone board, or a metal plate.

Referring to FIGS. 1 to 3, through surface treatment to the plural cleaning grains 211 of abrasive material contained in the cleaning material, the force of cross linking between the abrasive material and silicone is increased, thereby preventing the abrasive material from peeling and falling off in cleaning.

Referring to FIGS. 1 to 3, the cleaning grains 211 of abrasive material contained in the cleaning material are fine abrasive powder in a grain size of 2 µm to 5 µm.

Referring to FIGS. 1 to 3, the cleaning grains 211 of abrasive material contained in the cleaning material can be made of aluminum oxide, silicon nitride, boron nitride, silicon carbide, boron carbide or diamond, wherein at least one of them is inorganic fine powder.

Referring to FIGS. 1 to 3, the cleaning layer 20 can be made of silicone, and its silicone resin can be epoxy resin, polyurethane resin or acrylic resin.

Referring to FIGS. 1 to 3, silicone in the cleaning layer 20 can be a general type, a high-resilient type, a high-strength type, a mixture of general type and high-lifetime type, or a mixture of general type, high-lifetime type and high-strength type. As the tolerance and the degree of wrapping to the pierce of probe pin 40 are dependent on the types of silicone, the properties of various materials are needed; a complex design rather than a single material is used.

Referring to FIGS. 1 to 3, for silicone in the cleaning layer 20, the mixing ratio of the general type to the high-lifetime type is 0:1 to 1:1, and the optimum value is 1:1. For this ratio, a balance between the cost and the number of times of cleaning can be achieved.

Referring to FIGS. 1 to 3, the ratio of each abrasive grain 21 in the cleaning layer 20 to the cleaning grain 211 of the abrasive material contained in the cleaning material can be 1:2 to 1:4, in order to improve the cleaning efficiency.

Referring to FIGS. 1 to 3, for the release layer 10, the release film attached on a surface of the cleaning layer 20 can be a piece of fine-quality paper, a piece of glassine, a piece of paper coated with a release agent such as silicone, a piece of paper laminated with polyethylene, a polyethylene film or a polypropylene film.

Referring to FIGS. 1 to 3, when the cleaning sheet is used in 150~200° C., as the cleaning layer 20 and the substrate 30 are bonded adhesively, the backing adhesive can easily form air bubbles or can be displaced by high temperature. When the air bubbles are formed, the surface of cleaning sheet will not be even. Therefore, the cleaning layer 20 is directly formed integrally on the substrate 30, in order to solve the issue caused by adhering.

As silicone can be pierced, when the probe pin 40 pierces through the surface of silicone, the silicone containing the abrasive material will wrap the probe pin 40, and the dirt 41 on the surface of probe pin 40 will be separated from the probe pin 40 by the friction between the silicone and the probe pin 40. This friction force results from the complex body of silicone and abrasive material. Then, by using the fact that the silicone itself carries the negative charges and is provided with the lipophilic property, the dirt 41 or oil stain will be transferred onto the contact surface between the silicone and the probe pin 40. In addition, as the abrasive material is filled in the elastic body, the direct abrasive force to the probe pin 40 will be controlled based upon the fill-in ratio of the abrasive material. If the fill-in ratio is high, the hardness of silicone and the abrasive force will be increased, but it will also result in a risk of wearing on the tip of probe pin 40 and powder falling off from the tip of probe pin 40. On the contrary, if the fill-in ratio is low, the cleaning power will be insufficient.

Referring to FIGS. 1 to 3, mixing different types of silicone lies in that:
1. The resistance to the piercing of probe pin 40 is adjusted.
2. The resilient force of the silicone after piercing is increased. When the resilient force is increased, a same position can be pierced multiple times, opposite to other product that the probe pin 40 needs to be displaced once after each time of piercing. Therefore, the cost of client can be reduced.

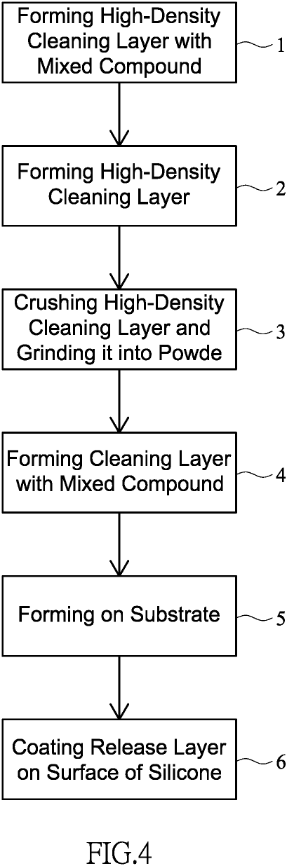

Referring to FIG. 1 and FIG. 4, the present invention discloses a probe pin cleaning sheet with cleaning power and a manufacturing method thereof, wherein the manufacturing method of the probe pin cleaning sheet comprises that:
1. The silicone and the fine abrasive powder are mixed in a special-purpose machine to form a mixed compound, thereby forming a high-density cleaning layer.
2. The mixed compound is formed into a high-density cleaning layer.
3. The high-density cleaning layer is crushed and ground into powder, with the grain size of fine abrasive powder of 0.05-0.2 mm.
4. The silicone and the fine abrasive powder are mixed in the special-purpose machine to form the mixed compound, thereby forming a cleaning layer.
5. The mixed compound is cut into a proper size and is then put on the substrate 30, followed by being put into a mold for forming, so as to form the cleaning layer 20 integrally on the substrate 30.
6. The release layer 10 is coated on the surface of silicone.

In comparing with the prior art, the probe pin cleaning sheet with cleaning power and the manufacturing method of the probe pin cleaning sheet, provided by the present invention, are provided with following advantages that:
1. Most of existing cleaning sheets are based upon a high polymer material added with an abrasive material. The abrasive material needs to be increased to improve the cleaning effect. However, when the filler (abrasive material) in the high polymer material is increased, the aggregation force among the molecules will drop. When the probe pin pierces repeatedly at a same location, the debris may fall off due to molecular scission. The silicone itself carries the negative charges, is provided with the lipophilic property, is compressible, but is not tolerated to piercing. Therefore, these properties are used as a basis for the present invention; in other words, the present invention aims to make the probe pin pierce through the cleaning layer and to transfer the dirt on the surface of probe pin onto the silicone.
2. The cleaning power is increased. The abrasive grains 21 are wrapped by the pure silicone. When the probe pin 40 pierces through the abrasive grains 21, the abrasive grains 21 will not expand outward further as the peripheries of abrasive grains 21 are limited by the compression of silicone, thereby increasing the wrapping capacity of the probe pin.
3. The thickness of cleaning layer is decreased. When the fill-in ratio is increased, the existing cleaning sheet will need to use a multi-layered structure design; therefore, a certain thickness is necessary.
4. The risk of falling-off of powder is reduced. As the abrasive grains 21 are wrapped by the pure silicone, the risk of falling-off of the abrasive grains 21 is reduced.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A probe pin cleaning sheet with cleaning power comprising:
a cleaning layer, which is provided with a cleaning material, with the cleaning material being formed by plural abrasive grains, each abrasive grain being formed by plural cleaning grains, and the cleaning layer being made of silicone resin;
a release layer, which is disposed on a surface of the cleaning layer, with the release layer being a release film being attached on a surface of the cleaning layer or a silicone coating being coated on a surface of the cleaning layer; and
a substrate, which is disposed on the other surface of cleaning layer, with that the cleaning layer is formed integrally with the cleaning material on the substrate or is bonded with the substrate adhesively after being formed;
wherein, in the process that the probe pin pierces the cleaning layer, through the material of cleaning layer, and the cleaning grains of abrasive material contained in the cleaning material in the cleaning layer, the cleaning power is increased to scrape off dirt from the surface of probe pin, in addition to that by the negative charges and lipophilic property of the silicon itself, the dirt on the probe pin is transferred onto the cleaning layer.

2. The probe pin cleaning sheet with cleaning power, according to claim 1, wherein the substrate is a fiberglass board, a plastic board, a synthetic stone board, or a metal plate.

3. The probe pin cleaning sheet with cleaning power, according to claim 1, wherein the plural cleaning grains of abrasive material contained in the cleaning material are processed with surface treatment.

4. The probe pin cleaning sheet with cleaning power, according to claim 3, wherein the cleaning grains of abrasive material contained in the cleaning material are fine abrasive powder in a grain size of 2 µm to 5 µm.

5. The probe pin cleaning sheet with cleaning power, according to claim 4, wherein the cleaning grains of abrasive material contained in the cleaning material is made of aluminum oxide, silicon nitride, boron nitride, silicon carbide, boron carbide or diamond, with at least one of them being inorganic fine powder.

6. The probe pin cleaning sheet with cleaning power, according to claim 1, wherein the silicone of the cleaning layer is epoxy resin, polyurethane resin or acrylic resin.

7. The probe pin cleaning sheet with cleaning power, according to claim 6, wherein the silicone in the cleaning layer is a general type, a high-resilient type, a high-strength type, a mixture of general type and high-lifetime type, or a mixture of general type, high-lifetime type and high-strength type.

8. The probe pin cleaning sheet with cleaning power, according to claim 7, wherein for the silicone of cleaning layer, the mixing ratio of the general type to the high-lifetime type is 0:1 to 1:1.

9. The probe pin cleaning sheet with cleaning power, according to claim 1, wherein the ratio of each abrasive grain in the cleaning layer to the cleaning grain of the abrasive material contained in the cleaning material is 1:2 to 1:4.

10. A manufacturing method of the probe pin cleaning sheet comprising steps of:
a) having silicone and fine abrasive powder mixed in a special-purpose machine to form a mixed compound, thereby forming a high-density cleaning layer;
b) having the mixed compound formed into a high-density cleaning layer;
c) having the high-density cleaning layer being crushed and ground into powder;
d) having the silicone and the fine abrasive powder mixed in the special-purpose machine to form the mixed compound, thereby forming a cleaning layer;
e) having the mixed compound cut into a proper size and then put on the substrate, followed by placing into a mold for forming, thereby forming the cleaning layer integrally on the substrate; and
f) having the release layer coated on the surface of silicone.

11. The manufacturing method of the probe pin cleaning sheet, according to claim 10, wherein the grain size of fine abrasive powder of 0.05~0.2 mm.
